(19) United States
(12) Patent Application Publication
(10) Pub. No.: US 2022/0227447 A1
(43) Pub. Date: Jul. 21, 2022

(54) CHASSIS FOR AN ELECTRIC VEHICLE

(71) Applicant: John Q McMillian, Russellville, TN (US)

(72) Inventor: John Q McMillian, Russellville, TN (US)

(21) Appl. No.: 17/580,230

(22) Filed: Jan. 20, 2022

Related U.S. Application Data
(60) Provisional application No. 63/140,213, filed on Jan. 21, 2021.

(51) Int. Cl. B62K 5/06; B62K 5/027

(52) U.S. Cl. CPC B62K 5/06; B62K 5/027

(57) ABSTRACT

A chassis for an electric autocycle. The chassis includes a front member, a rear member, a left member, and a right member forming a trapezoidal tubular frame. The front member is shorter in length than the rear member. Three traverse members i.e., a first traverse member, a second traverse member, and a third traverse member those extend between the left member and the right member, the three traverse members are parallel to each other and the front member and the rear member. Two longitudinal members i.e., a first longitudinal member and a second longitudinal member both extend between the front member and the rear member and are perpendicular to the rear member. Two support members, i.e., a first support member and a second support member extend between the first traverse member and the rear member, the two support members are perpendicular to the rear member. The area between the rear member and the first traverse member forms a battery area where batteries are placed. The chassis further has a tail portion that can be square or rectangular and extends away from the rear member.

### CROSS-REFERENCE TO RELATED APPLICATIONS

This application claims priority from a U.S. provisional patent application Ser. No. 63/140,213, filed on Jan. 21, 2021, which is incorporated herein by reference in its entirety.

### FIELD OF INVENTION

The present invention relates to a chassis for an electric vehicle, and more particularly, the present invention relates to a delta shape chassis for an electric autocycle.

### BACKGROUND

Autocycle, also known as a three-wheeler, is a vehicle with three wheels. Autocycles have one wheel in the front and two wheels in the rear (delta design). Also, are known autocycle having two wheels in front and one wheel in the rear (tadpole design). The present disclosure is related to motorized autocycle with a single front wheel and two rear wheels, and the term autocycle or trike or three-wheeler or vehicle are all interchangeably used hereinafter and refer to the motorized autocycle with the single front wheel and two rear wheels.

The chassis, like in other vehicles, is a frame in the autocycles over which other components of the autocycle are assembled. In designing a chassis for a vehicle, many factors are considered, such as the overall design of the vehicle, weight, and safety features. Chassis bears the weight of the vehicle as well as that of the payload. Additionally, the chassis can keep the vehicle stable during motion, braking, and stationary. Chassis also becomes a critical component of the overall safety system of the vehicle, such as in collisions.

Electric vehicles have become quite popular in the last decade and are replacing fuel-based engines. Similarly, the popularity and demand for electric autocycles have also been increasing exponentially. However, the electrification of autocycles poses new challenges for the chassis design, and in particular to the stability and safety perspective of the chassis for autocycles.

Thus, there exists an industry need for improved chassis design for electric autocycles that can handle the added load of batteries and provide both stability and safety to the electric autocycles.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a chassis for an electric autocycle.

It is another object of the present invention that the chassis can provide an ultra-low center of gravity to enhance stability.

It is yet another object of the present invention that the chassis can add to the safety of the electric autocycle keeping the driver safe in case of head-on collisions.

It is a further object of the present invention that the chassis can improve the overall performance of the electric autocycle.

In one implementation, disclosed is a chassis for a vehicle comprising a front member, a rear member, a left member, and a right member those define a trapezoidal frame, wherein the front member is shorter in length than the rear member, the front member and the rear member are parallel to each other, the left member and the right member are of same lengths and extend between the front member and the rear member; a first longitudinal member and a second longitudinal member extend between the front member and the rear member, the first longitudinal member and the second longitudinal member are parallel to each other and perpendicular to the rear member, the first longitudinal member and the second longitudinal member are spaced apart from each other; and a first traverse member extends between the left member and the right member, the first traverse member is parallel to the rear member, the first traverse member is smaller in length than the rear member, wherein a battery area extends between the rear member and the first traverse member, a plurality of batteries can be placed on the battery area.

In one implementation of the chassis, the chassis further comprises a second traverse member that extends between the left member and the right member, the second traverse member is parallel to the rear member, the second traverse member is smaller in length than the first traverse member. The chassis further comprises a third traverse member that extends between the left member and the right member, the third traverse member is parallel to the rear member, the third traverse member is smaller in length than the second traverse member. The chassis further comprises a first leg, a second leg, and a third leg, wherein the first leg, the second leg, the third leg, and a portion of the rear member form a square or rectangular shape tail portion. The chassis further comprises a first support member and a second support member those extend between the first traverse member and the rear member, the first support member and the second support member are parallel to each other and perpendicular to the rear member. The tail portion is configured to mount a rear-drive unit of the vehicle, and the front member is configured to mount a single front steering wheel. The vehicle is an electric autocycle, the electric autocycle has a single front wheel and two rear wheels.

In one aspect, disclosed is a vehicle comprising a chassis, the chassis comprising a front member, a rear member, a left member, and a right member those define a trapezoidal frame, wherein the front member is shorter in length than the rear member, the front member and the rear member are parallel to each other, the left member and the right member are of same lengths and extend between the front member and the rear member; a first longitudinal member and a second longitudinal member extend between the front member and the rear member, the first longitudinal member and the second longitudinal member are parallel to each other and perpendicular to the rear member, the first longitudinal member and the second longitudinal member are spaced apart from each other; and a first traverse member extends between the left member and the right member, the first traverse member is parallel to the rear member, the first traverse member is smaller in length than the rear member, wherein a battery area extends between the rear member and the first traverse member, a plurality of batteries can be placed on the battery area, wherein the vehicle further comprises the plurality of batteries mounted on the battery area.

In one implementation of the vehicle, the chassis further comprises a second traverse member that extends between the left member and the right member, the second traverse member is parallel to the rear member, the second traverse member is smaller in length than the first traverse member. The chassis further comprises a third traverse member that extends between the left member and the right member, the third traverse member is parallel to the rear member, the third traverse member is smaller in length than the second traverse member. The chassis further comprises a first leg, a second leg, and a third leg, wherein the first leg, the second leg, the third leg, and a portion of the rear member form a square or rectangular shape tail portion. The chassis further comprises a first support member and a second support member those extend between the first traverse member and the rear member, the first support member and the second support member are parallel to each other and perpendicular to the rear member. The vehicle further comprises a rear-drive unit mounted to the tail portion; and a single front steering wheel mounted to the front member. The vehicle is an electric autocycle, the electric autocycle has a single front wheel and two rear wheels.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a schematic top plan view of the chassis for electric autocycles shown to be of a delta shape, according to an exemplary embodiment of the present invention

FIG. 2 is a schematic top plan view of the chassis with ancillary equipment, according to an exemplary embodiment of the present invention

FIG. 3 is a schematic top plan view as in FIG. 2 also showing the batteries and center of gravity alignment, according to an exemplary embodiment of the present invention.

FIG. 4 is a side elevation view of the chassis with ancillary equipment and batteries as shown in FIG. 3, according to an exemplary embodiment of the present invention.

FIG. 5 illustrates the chassis of FIG. 2 get deflected on near head-on collision with a car, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a three-wheeled Delta-shaped electric autocycle and a chassis for the autocycle. The autocycle can have a single front wheel and dual rear wheels. The chassis and the autocycle can support three passengers. The disclosed chassis is particularly suitable for electric autocycles, wherein the chassis can easily handle a battery weight of up to 900 pounds along with three occupants. Besides being strong and supportive, the disclosed chassis is particularly advantageous by providing a deflective barrier in case of a nearly head-on collision. The position of the batteries on the chasing is another key advantage by providing an ultra-low center of gravity, well within the stability triangle, providing enhanced safety, improved performance, and superior stability.

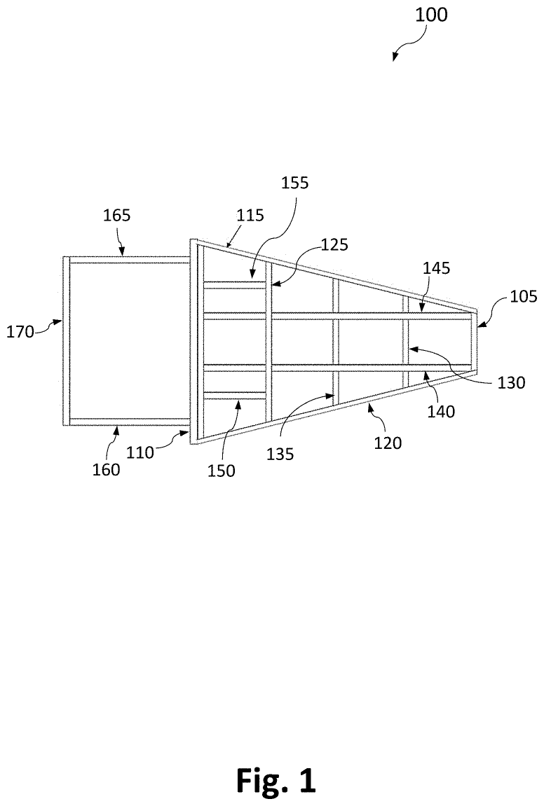

Referring to FIG. 1 which shows an exemplary embodiment of the disclosed chassis 100 for an electric autocycle. The chassis 100 can include a front member 105, a rear member 110, a left member 115, and a right member 120, all of a tubular geometry. The front member 105 can be at the front side of the autocycle and the rear member 110 can be at the rear of the autocycle. The front member 105, the rear member 110, the left member 115, and the right member 120 form a trapezoid-like geometry, wherein the front member 105 is shorter in length than the rear member 110. The chassis 100 can be made from tubular members that can be fabricated from strong materials such as steel and aluminum. FIG. 1 further shows a first traverse member 125, a second traverse member 130, and a third traverse member 135 all extend between the left member 115 and the right member 120, the three traverse members can be parallel to each other and the front member and the rear member. The first traverse member can be adjacent to the rear member, the second traverse member can be adjacent to the front member, and the third traverse member can be between the first traverse member and the second traverse member. FIG. 1 further shows a first longitudinal member 140 and a second longitudinal member 145 both extending between the front member 105 and the rear member 110. The first longitudinal member and the second longitudinal member can be perpendicular to the rear member 110. Two support members, i.e., a first support member 150 and a second support member 155 can also be seen in FIG. 1 extending between the first traverse member 125 and the rear member 110, wherein the two support members can be perpendicular to the rear member 110. The chassis 100 can further comprise a tail portion that extends away from the rear member 110. The tail portion can include a first leg 160 and a second leg 165 both parallel to each other and extend perpendicularly from the rear member 110. A third leg 170 extends between the first leg 160 and the second leg 165, such that the first leg 160, the second leg 165, a portion of the rear member 110, and the third leg 170 can form a square or rectangular geometry.

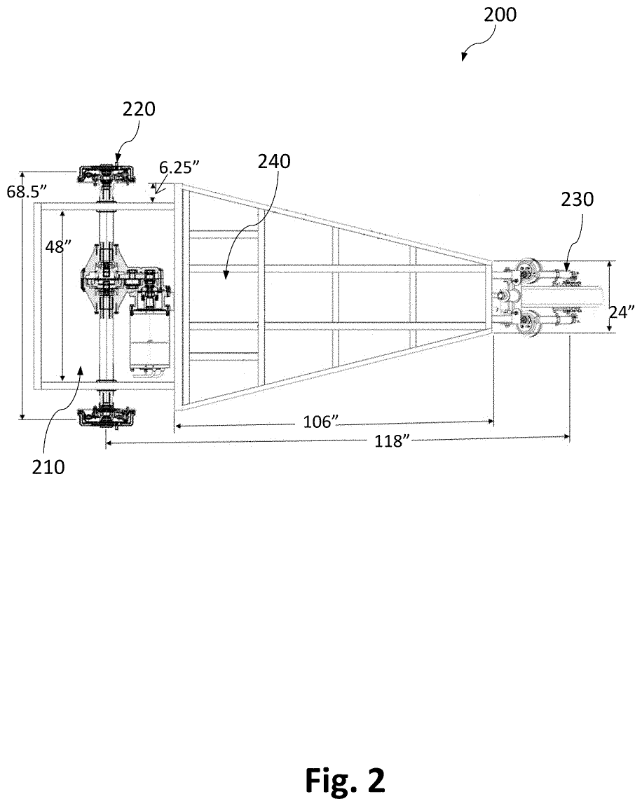

Referring to FIG. 2 which shows the chassis 200 mounted with ancillary equipment. Ancillary equipment and or components with a variety of specific designs, measurements, and uses, may be mounted and may have no impact on the chassis function. FIG. 2 also shows the dimensions of various parts of the chassis. To the tail portion 210 can be mounted a rear-drive unit 220 of the autocycle. The elevation of the tail portion 210 can be raised (or lowered) as necessary to facilitate road clearance. A single front steering wheel 230 can be mounted to the front member or front portion of the chassis 200. The battery area 240 extends between the first traverse member 125 and the rear member 110 and can further be supported by the two support members and the two longitudinal members, the battery area can support the batteries. The batteries can be mounted directly on the battery area 240 in front of the rear-drive unit 220. Such a location of the batteries can provide an ultra-low center of gravity, well within the stability triangle, providing enhanced safety, improved performance, and superior stability. The battery area 240, the longitudinal members, and the traverse members can provide the desired strength and durability to the frame. In one case, the chassis can be made from a 2-inch tubular steel frame and the tubular members of the chassis can be welded to each other.

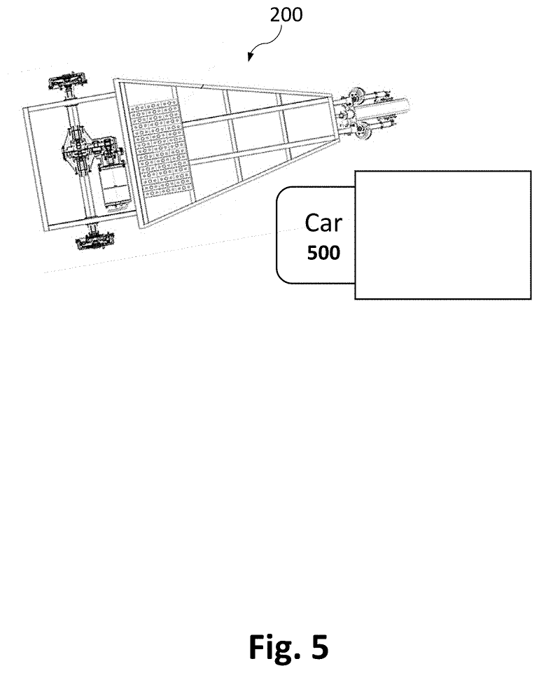

In one implementation, an average width of the vehicle can be about 78 inches and an average width of the front of the chassis can be about 24 inches or one-third of the width of the vehicle (this shape is referred to as Delta). The center of gravity and the delta shape can reduce the chances of true head-on collision by at least two-thirds. The vehicle, with the triangle-shaped chassis, when colliding with an object, the chassis can deflect or glance off to one side or the other, and the driver and the passengers may remain safe. It is without any doubt that passenger safety is of critical importance. Provided with seatbelts, shoulder harnesses, and a roll-bar, vehicle passengers are protected from both a true head-on collision as well as a vehicle rollover. The roll-bar is not illustrated in the drawings and is not part of the chassis. FIG. 5 shows how the chassis 200 can help reducing the force of impact from a near head-on collision with another vehicle 500 which is shown to be a car. The chassis gets deflected sidewards from the impact and thus keeping the driver and the passengers safe.

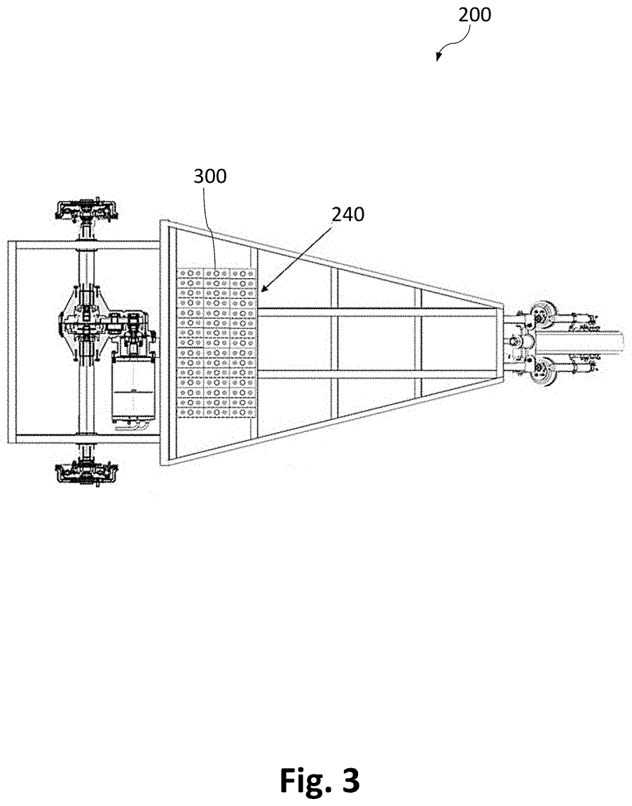

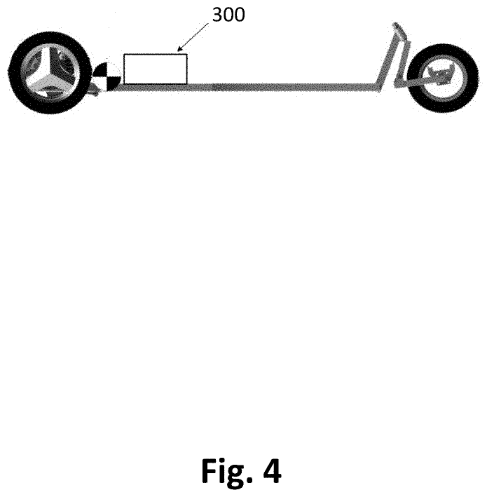

Referring to FIGS. 3 and 4, which also show the batteries strategically placed in the battery area 240 to provide an ultra-low center of gravity to enhance stability. Batteries can be mounted on the chassis and under the rear seat when the body of the vehicle is in place. The chassis can be about 24 inches wide in the front and about 52 inches wide at the point where the chassis conforms to the dimensions of the motor/transaxle. Additionally, at the area in front of the rear wheels, the chassis extends to cover (protect) the rear tires and can be about 68.5 inches wide.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A chassis for a vehicle comprising:
a front member, a rear member, a left member, and a right member those define a trapezoidal frame, wherein the front member is shorter in length than the rear member, the front member and the rear member are parallel to each other, the left member and the right member are of same lengths and extend between the front member and the rear member;
a first longitudinal member and a second longitudinal member extend between the front member and the rear member, the first longitudinal member and the second longitudinal member are parallel to each other and perpendicular to the rear member, the first longitudinal member and the second longitudinal member are spaced apart from each other; and
a first traverse member extends between the left member and the right member, the first traverse member is parallel to the rear member, the first traverse member is smaller in length than the rear member,
wherein a battery area extends between the rear member and the first traverse member, a plurality of batteries can be placed on the battery area.

2. The chassis according to claim 1, wherein the chassis further comprises:
a second traverse member that extends between the left member and the right member, the second traverse member is parallel to the rear member, the second traverse member is smaller in length than the first traverse member.

3. The chassis according to claim 2, wherein the chassis further comprises:
a third traverse member that extends between the left member and the right member, the third traverse member is parallel to the rear member, the third traverse member is smaller in length than the second traverse member.

4. The chassis according to claim 2, wherein the chassis further comprises:
a first leg, a second leg, and a third leg, wherein the first leg, the second leg, the third leg, and a portion of the rear member form a square or rectangular shape tail portion.

5. The chassis according to claim 4, wherein the chassis further comprises:
a first support member and a second support member those extend between the first traverse member and the rear member, the first support member and the second support member are parallel to each other and perpendicular to the rear member.

6. The chassis according to claim 5, wherein the tail portion is configured to mount a rear-drive unit of the vehicle, and the front member is configured to mount a single front steering wheel.

7. The chassis according to claim 6, wherein the vehicle is an electric autocycle, the electric autocycle has a single front wheel and two rear wheels.

8. A vehicle comprising:
a chassis comprising:
a front member, a rear member, a left member, and a right member those define a trapezoidal frame, wherein the front member is shorter in length than the rear member, the front member and the rear member are parallel to each other, the left member and the right member are of same lengths and extend between the front member and the rear member;
a first longitudinal member and a second longitudinal member extend between the front member and the rear member, the first longitudinal member and the second longitudinal member are parallel to each other and perpendicular to the rear member, the first longitudinal member and the second longitudinal member are spaced apart from each other; and
a first traverse member extends between the left member and the right member, the first traverse member is parallel to the rear member, the first traverse member is smaller in length than the rear member,
wherein a battery area extends between the rear member and the first traverse member, a plurality of batteries can be placed on the battery area,
wherein the vehicle further comprises the plurality of batteries mounted on the battery area.

9. The vehicle according to claim 8, wherein the chassis further comprises:
a second traverse member that extends between the left member and the right member, the second traverse member is parallel to the rear member, the second traverse member is smaller in length than the first traverse member.

10. The vehicle according to claim 9, wherein the chassis further comprises:
a third traverse member that extends between the left member and the right member, the third traverse member is parallel to the rear member, the third traverse member is smaller in length than the second traverse member.

11. The vehicle according to claim 10, wherein the chassis further comprises:
a first leg, a second leg, and a third leg, wherein the first leg, the second leg, the third leg, and a portion of the rear member form a square or rectangular shape tail portion.

12. The vehicle according to claim 11, wherein the chassis further comprises:
a first support member and a second support member those extend between the first traverse member and the rear member, the first support member and the second support member are parallel to each other and perpendicular to the rear member.

13. The vehicle according to claim 12, wherein the vehicle further comprises:
a rear-drive unit mounted to the tail portion; and
a single front steering wheel mounted to the front member.

14. The vehicle according to claim 13, wherein the vehicle is an electric autocycle, the electric autocycle has a single front wheel and two rear wheels.
